(19) United States
(12) Patent Application Publication
(10) Pub. No.: US 2022/0036491 A1
(43) Pub. Date: Feb. 3, 2022

(54) METHOD, SYSTEM, AND NON-TRANSITORY COMPUTER-READABLE RECORDING MEDIUM FOR PROVIDING LEARNER-PERSONALIZED EDUCATION SERVICE

(71) Applicant: CLASSCUBE CO., LTD., Seoul (KR)

(72) Inventor: Seong Chan AHN, Seoul (KR)

(73) Assignee: CLASSCUBE CO., LTD., Seoul (KR)

(21) Appl. No.: 17/505,012

(22) Filed: Oct. 19, 2021

Related U.S. Application Data
(63) Continuation of application No. PCT/KR2020/004759, filed on Apr. 8, 2020.

(30) Foreign Application Priority Data
Apr. 23, 2019 (KR) 10-2019-0047581

(51) Int. Cl. G06Q 50/20; G06N 5/02

(52) U.S. Cl. CPC G06Q 50/205; G06N 5/02

(57) ABSTRACT

A method for providing a customized education service to a learner is provided. The method includes the steps of: determining a personalized learning objective on the basis of at least one learning objective provided from a learner; determining an objective relevance for at least one learning unit associated with at least one of the learning objective and the personalized learning objective; and recommending the learner a learning solution associated with at least one learning unit for which the objective relevance is not less than a predetermined level, wherein the step of determining the personalized learning objective comprises the step of determining the personalized learning objective on the further basis of the determined objective relevance.

### CROSS-REFERENCE TO RELATED APPLICATION(S)

This application is a continuation application of Patent Cooperation Treaty (PCT) International Application No. PCT/KR2020/004759 filed on Apr. 8, 2020, which claims priority to Korean Patent Application No. 10-2019-0047581 filed on Apr. 23, 2019. The entire contents of PCT International Application No. PCT/KR2020/004759 and Korean Patent Application No. 10-2019-0047581 are hereby incorporated by reference.

### FIELD OF THE INVENTION

The present invention relates to a method, system, and non-transitory computer-readable recording medium for providing an education service customized for a learner.

### BACKGROUND

With the development of information and communication technology, various learning methods are emerging which allow a learner to make progress in learning according to his/her own conditions, contrary to traditional learning methods in which a learner actually meets a teacher to perform learning through the guidance of the teacher.

Particularly, active learning methods, which allow a learner to initiatively perform learning at a desired time and place using a communication network, are lively employed in various educational fields.

In conventional techniques introduced so far, it is general that learning information is provided sequentially (in reverse order when a review is required) according to a predetermined learning system such as a standard curriculum. For example, when a learner aiming at admission to department B of university A shows a low academic achievement for a specific subject (or a specific unit of the specific subject), learning information for increasing the academic achievement for the specific subject (or the specific unit of the specific subject) is provided according to a predefined learning system, regardless of learning objectives required for admission to department B of university A.

However, according to the above conventional techniques, learning information is provided only in a fixed order or pattern according to a predetermined learning system. Therefore, there is a limitation that uniform learning information is provided to all learners without considering actual learning objectives of the learners, and there occurs a problem that efficient learning cannot be performed as a learner is provided with all learning information that is unnecessary for the learner.

### SUMMARY OF THE INVENTION

One object of the present invention is to solve all the above-described problems in prior art.

Another object of the invention is to provide a customized education service to a learner by determining a personalized learning objective on the basis of at least one learning objective provided from a learner, determining an objective relevance for at least one learning unit associated with at least one of the learning objective and the personalized learning objective, and recommending the learner a learning solution associated with at least one learning unit for which the objective relevance is not less than a predetermined level.

The representative configurations of the invention to achieve the above objects are described below.

According to one aspect of the invention, there is provided a method for providing a customized education service to a learner, the method comprising the steps of: determining a personalized learning objective on the basis of at least one learning objective provided from a learner; determining an objective relevance for at least one learning unit associated with at least one of the learning objective and the personalized learning objective; and recommending the learner a learning solution associated with at least one learning unit for which the objective relevance is not less than a predetermined level, wherein the step of determining the personalized learning objective comprises the step of determining the personalized learning objective on the further basis of the determined objective relevance.

According to another aspect of the invention, there is provided a system for providing a customized education service to a learner, the system comprising: a learning objective management unit configured to determine a personalized learning objective on the basis of at least one learning objective provided from a learner; a relevance management unit configured to determine an objective relevance for at least one learning unit associated with at least one of the learning objective and the personalized learning objective; and a recommendation unit configured to recommend the learner a learning solution associated with at least one learning unit for which the objective relevance is not less than a predetermined level, wherein the learning objective management unit is configured to determine the personalized learning objective on the further basis of the objective relevance determined by the relevance management unit.

In addition, there are further provided other methods and systems to implement the invention, as well as non-transitory computer-readable recording media having stored thereon computer programs for executing the methods.

According to the invention, it is possible to recommend a learner a learning solution associated with at least one learning unit that is associated with at least one of at least one learning objective provided by the learner and a personalized learning objective determined on the basis of the at least one learning objective, and has an objective relevance not less than a predetermined level, so that learning units necessary for individual learners may be found accurately and efficiently.

According to the invention, it is possible to selectively provide a learner with only learning information on learning units necessary for achieving his/her learning objectives, so that the efficiency of learning may be improved.

According to the invention, it is possible to continuously evaluate academic achievements in the process of learning progress according to a learning solution recommended to a learner, so that errors or deficiencies in the learning progress of the learner may be immediately remedied.

### BRIEF DESCRIPTION OF THE DRAWINGS

FIG. 1 schematically shows the configuration of an entire system for providing a learning solution according to one embodiment of the invention.

FIG. 2 illustratively shows the internal configuration of a learning solution provision system according to one embodiment of the invention.

FIG. 3A illustratively shows a learner's academic achievements for learning units according to one embodiment of the invention.

FIG. 3B illustratively shows how a personalized learning objective is determined on the basis of a learning objective of a learner and objective relevances according to one embodiment of the invention.

FIG. 4 conceptually shows the process of determining a personalized learning objective according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

A learning objective according to the invention refers to information provided from a learner to determine a personalized learning objective. For example, the learning objective may include a subject for which the learner desires to increase his/her academic achievement, a target test score, a target high school, a target university, a target major, and a target occupation. However, the learning objective according to the invention is not limited to those mentioned above, and may be diversely changed as long as the objects of the invention may be achieved.

A learning unit according to the invention refers to a unit in which learning information is provided to a learner, and may be defined on the basis of a subject, a grade, and a curriculum unit, for example. According to one embodiment of the invention, the learning information included in the learning unit may be classified according to stages such as concept learning, drilling, and in-depth learning, and the learning information corresponding to each stage may include textbooks, questions by difficulties, learning materials, and the like. However, the learning unit according to the invention is not limited to those mentioned above, and may be diversely changed as long as the objects of the invention may be achieved.

A personalized learning objective according to the invention refers to a required achievement for at least one learning unit necessary for achieving a learning objective. For example, the personalized learning objective may include a subject to be learned, a required achievement for each subject, a required achievement for a specific unit of the subject to be learned, a required achievement for a subpart included in the specific unit of the subject to be learned, a required academic grade, and a pathway for achieving the learning objective. However, the personalized learning objective according to the invention is not limited to those mentioned above, and may be diversely changed as long as the objects of the invention may be achieved.

An objective relevance according to the invention refers to a weight assigned to at least one learning unit, and indicates a relationship between the at least one learning unit and a learning objective or a personalized learning objective. The objective relevance may encompass a grade (e.g., a three-level grade such as “High”, “Medium”, or “Low”), a numerical value (e.g., a quantified numerical value), or the like. However, the objective relevance according to the invention is not limited to those mentioned above, and may be diversely changed as long as the objects of the invention may be achieved.

Hereinafter, preferred embodiments of the present invention will be described in detail with reference to the accompanying drawings to enable those skilled in the art to easily implement the invention.

Configuration of an Entire System

FIG. 1 schematically shows the configuration of an entire system for providing a learning solution according to one embodiment of the invention.

As shown in FIG. 1, the entire system according to one embodiment of the invention may comprise a communication network 100, a learning solution provision system 200, and a user terminal device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the learning solution provision system 200 according to one embodiment of the invention may function to provide a customized education service to a learner by determining a personalized learning objective on the basis of at least one learning objective provided from a learner, determining an objective relevance for at least one learning unit associated with at least one of the learning objective and the personalized learning objective, and recommending the learner a learning solution associated with at least one learning unit for which the objective relevance is not less than a predetermined level.

The configuration and functions of the learning solution provision system 200 according to the invention will be discussed in detail in the following description.

Next, the user terminal device 300 according to one embodiment of the invention is digital equipment capable of allowing a user to connect to and then communicate with the learning solution provision system 200, and any type of digital equipment having a microprocessor and a memory means for computing capabilities, such as smart phones, tablets, smart watches, smart bands, smart glasses, desktop computers, notebook computers, workstations, personal digital assistants (PDAs), web pads, and mobile phones, may be adopted as the user terminal device 300 according to the invention.

Particularly, the user terminal device 300 may include an application (not shown) to assist a user to receive services such as learning solutions from the learning solution provision system 200. The application may be downloaded from the learning solution provision system 200 or a known web server (not shown).

Configuration of the Learning Solution Provision System

Hereinafter, the internal configuration of the learning solution provision system crucial for implementing the invention and the functions of the respective components thereof will be discussed.

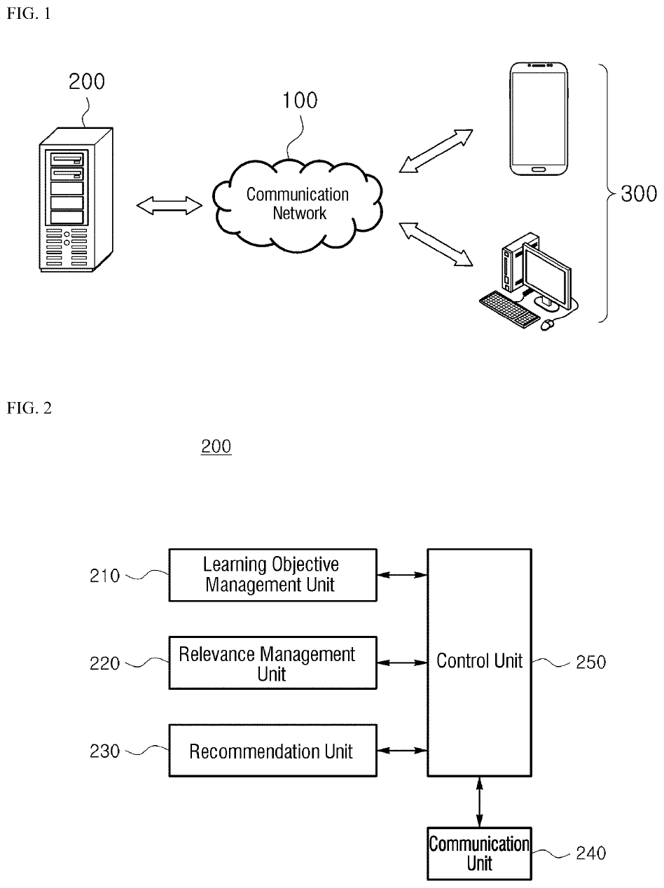

FIG. 2 illustratively shows the internal configuration of the learning solution provision system according to one embodiment of the invention.

Referring to FIG. 2, the learning solution provision system 200 according to one embodiment of the invention may comprise a learning objective management unit 210, a relevance management unit 220, a recommendation unit 230, a communication unit 240, and a control unit 250. According to one embodiment of the invention, at least some of the learning objective management unit 210, the relevance management unit 220, the recommendation unit 230, the communication unit 240, and the control unit 250 may be program modules to communicate with an external system (not shown). The program modules may be included in the learning solution provision system 200 in the form of operating systems, application program modules, and other program modules, while they may be physically stored in a variety of commonly known storage devices. Further, the program modules may also be stored in a remote storage device that may communicate with the learning solution provision system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the learning objective management unit 210 may function to determine a personalized learning objective on the basis of at least one learning objective provided from a learner and an objective relevance determined by the relevance management unit 220.

Specifically, according to one embodiment of the invention, when the learner connects to a server of a provider of an education service customized for the learner and enters personal information, the server of the service provider prepares to provide the service.

The personal information may be entered through known procedures for membership registration and log-in. The entered personal information may include a name, address, age, grade, school, institution, and the like of the learner.

Meanwhile, according to another embodiment of the invention, the online membership registration and log-in procedures as above are not necessarily required. For example, the service provider may prepare to provide the service as the learner makes a simple phone call with the service provider to request the service, or the learner personally visits the service provider to request the service offline. In this case, the learner's personal information collected offline may be stored in a database to be available online later.

Further, when the preparation for the service provision is completed, test questions for determining a learning objective personalized for the learner are provided to the learner. According to one embodiment of the invention, when the learner connects to the server via a communication network using a terminal and receives the test questions, the test questions may be displayed to the learner via a graphical user interface (GUI). According to another embodiment of the invention, when the learner receives the test questions offline, a test paper containing the test questions may be provided to the learner. Of course, the test questions received by the learner may be provided via the learner's e-mail account.

Meanwhile, the provided test questions include contents necessary for determining the learning objective personalized for the learner, and may be related to a target university, a target major, or a target occupation, for example.

Next, when the learner answers the test questions, the answers are aggregated and evaluated. Here, the aggregation and evaluation for the test questions may be performed with reference to a reference database that may be autonomously operated and managed or separately provided. The reference database may include a table of evaluation criteria for the respective test questions for deriving the learning objective personalized for the learner according to the learner's answers.

Further, the reference database may be updated with reference to an external database. For example, when qualification information for admission to a specific department of a specific university or qualification information required to have a specific occupation is changed, the reference database may be automatically updated by the server operated by the service provider.

When the aggregation and evaluation of the learner's answers are completed, the learning objective personalized for the learner is determined on the basis of the aggregation and evaluation. Meanwhile, according to one embodiment of the invention, the learning objective personalized for the learner may be determined on the further basis of the objective relevance to be described in detail below. For example, according to one embodiment of the invention, when the target occupation or target university of the learner is derived on the basis of the learning objective provided from the learner or the aggregation and evaluation of the learner's answers, learning units whose objective relevances for the target occupation or target university are not less than a predetermined level may be determined as the learning objective personalized for the learner.

Next, according to one embodiment of the invention, the relevance management unit 220 may function to determine an objective relevance for at least one learning unit associated with at least one of the learning objective and the personalized learning objective.

Specifically, the relevance management unit 220 may function to define a knowledge map including at least one node corresponding to at least one learning unit, an objective relevance assigned to each of the at least one node, and at least one link which connects two or more nodes and is assigned a correlation between two or more learning units. According to one embodiment of the invention, an initial state of multiple nodes and links constituting the knowledge map may be basically defined on the basis of a learning system (e.g., an occupation relationship, a subject, a grade, a curriculum unit, etc.) predefined for multiple learning units.

Meanwhile, according to one embodiment of the invention, a node constituting the knowledge map may be assigned an objective relevance, which indicates a relationship between a learning unit corresponding to the node and the learning objective of the learner or the learning objective personalized for the learner, as a weight.

Specifically, according to one embodiment of the invention, the objective relevance assigned to the node in the knowledge map may be determined on the basis of whether learning of the learning unit corresponding to the node is necessary for achieving the learning objective of the learner. For example, when learning of a specific subject (or a specific unit of the specific subject) is necessary for achieving the learning objective of the learner, a greater objective relevance may be assigned to a corresponding node.

Meanwhile, according to one embodiment of the invention, the objective relevance assigned to the node in the knowledge map may be dynamically determined on the basis of nodes that at least one learner has traversed on the knowledge map while performing a learning solution for at least one learning unit. For example, a greater objective relevance may be assigned to a node that the at least one learner has traversed more frequently while performing the learning solution.

Further, according to one embodiment of the invention, the objective relevance assigned to the node in the knowledge map may be dynamically determined on the basis of academic achievements of at least one learner for learning units corresponding to nodes that the at least one learner has traversed on the knowledge map while performing a learning solution for at least one learning unit. For example, a greater objective relevance may be assigned to a node for which the at least one learner has shown a lower academic achievement.

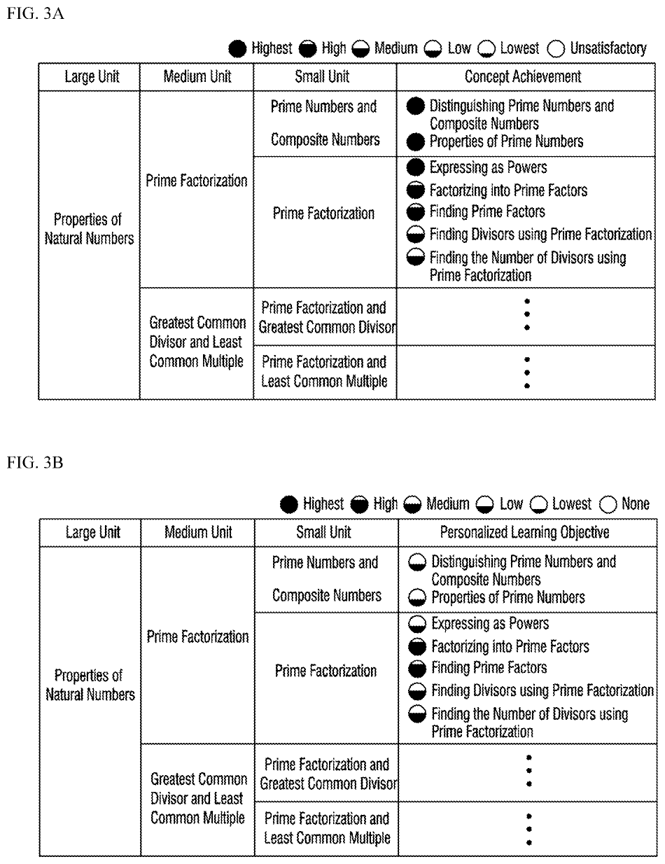

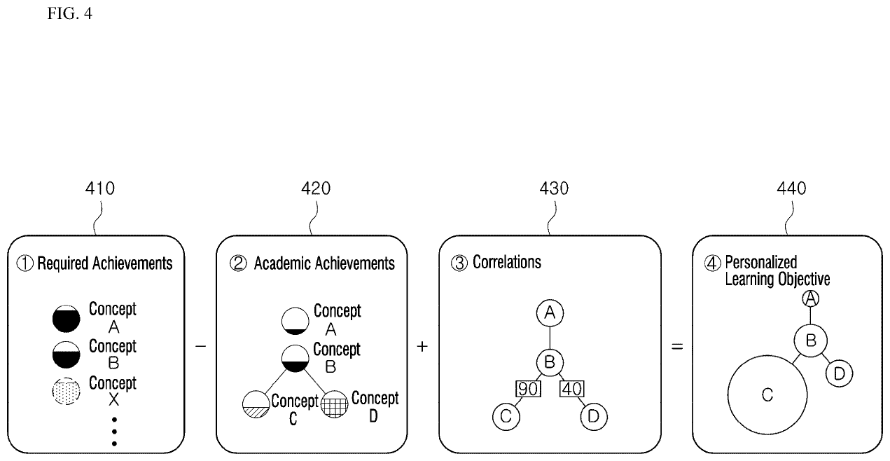

FIG. 3A illustratively shows a learner's academic achievements for learning units according to one embodiment of the invention.

FIG. 3B illustratively shows how a personalized learning objective is determined on the basis of a learning objective of a learner and objective relevances according to one embodiment of the invention.

Referring to FIGS. 3A and 3B, the relevance management unit 220 according to one embodiment of the invention may assign an objective relevance to each learning unit on the basis of a required achievement, an academic achievement, and the like for a specific learning unit necessary for achieving the learning objective of the learner, and the learning objective management unit 210 according to one embodiment of the invention may determine the personalized learning object on the basis of the learning objective of the learner and the assigned objective relevance.

For example, referring to FIG. 3A, when learning of “Properties of Natural Numbers” in a mathematics subject is necessary for achieving the learning objective of the learner, and the learner has shown high academic achievements for a “Prime Numbers and Composite Numbers” unit and an “Expressing as Powers” part of a “Prime Factorization” unit, less objective relevances may be assigned to the corresponding learning units, i.e., a “Distinguishing Prime Numbers and Composite Numbers” part of the “Prime Numbers and Composite Numbers” unit, a “Properties of Prime Numbers” part of the “Prime Numbers and Composite Numbers” unit, and the “Expressing as Powers” part of the “Prime Factorization” unit. Meanwhile, even if the learner has shown high academic achievements for a “Factorizing into Prime Factors” part and a “Finding Prime Factors” part of the “Prime Factorization” unit, greater objective relevances may be assigned to the “Factorizing into Prime Factors” part and the “Finding Prime Factors” part of the “Prime Factorization” unit when the learner has traversed the nodes corresponding to the above parts more frequently while performing a learning solution. Further, referring to FIG. 3B, the learning objective management unit 210 according to one embodiment of the invention may determine the personalized learning object on the basis of objective relevances assigned to subparts of the “Properties of Natural Numbers” unit in the mathematics subject. That is, referring to FIG. 3B, a required achievement included in the personalized learning objective may be determined to be higher as a corresponding part has a greater objective relevance.

Further, according to one embodiment of the invention, a link constituting the knowledge map may be assigned a correlation between two learning units each corresponding to two nodes connected by the link as a weight.

Specifically, according to one embodiment of the invention, the correlation assigned to the link in the knowledge map may be dynamically determined on the basis of nodes and links that at least one learner has traversed on the knowledge map while performing a learning solution for two or more learning units. For example, a greater correlation may be assigned to a link that the at least one learner has traversed more frequently while performing the learning solution.

Further, according to one embodiment of the invention, the correlation assigned to the link in the knowledge map may be dynamically determined on the basis of academic achievements of at least one learner for learning units corresponding to nodes that the at least one learner has traversed on the knowledge map while performing a learning solution for two or more learning units. For example, a greater correlation may be assigned to a link connected toward a node for which the at least one learner has shown a lower academic achievement.

Meanwhile, according to one embodiment of the invention, the relevance management unit 220 may change the configuration of the knowledge map (i.e., the connection relationship between the nodes by the links) on the basis of the correlations dynamically assigned to the links in the knowledge map.

Specifically, when a correlation between two learning units each corresponding to two nodes connected by a link in the knowledge map is less than a predefined level, the relevance management unit 220 according to one embodiment of the invention may function to remove the existing link connecting the two nodes each corresponding to the two learning units.

Further, when two learning units each corresponding to two nodes not connected by a link share a specific learning unit having a correlation not less than a predefined level, the relevance management unit 220 according to one embodiment of the invention may create a new link connecting the two nodes each corresponding to the two learning units.

FIG. 4 conceptually shows the process of determining a personalized learning objective according to one embodiment of the invention.

For example, referring to FIG. 4, required achievements 410 of respective nodes included in a personalized learning objective 440 may be determined from a learning objective of a learner, and the personalized learning objective 440 may be determined in consideration of the required achievements 410 of the respective nodes and objective relevances (not shown) of the respective nodes, which may be dynamically determined by academic achievements 420 of the learner for the respective nodes and correlations 430 between the respective nodes.

Next, according to one embodiment of the invention, the recommendation unit 230 may function to recommend the learner a learning solution associated with at least one learning unit for which the objective relevance is not less than a predetermined level.

Specifically, the recommended learning solution may be appropriately selected in consideration of a personalized learning objective and an objective relevance assigned to a node corresponding to at least one learning unit. For example, when objective relevances of a mathematics subject and a science subject (or specific units of the mathematics and science subjects) are high whereas objective relevances of other subjects are low, a learning solution may be recommended in such a way that academic achievements for the mathematics and science subjects (or the specific units thereof) may be increased.

Further, the recommended learning solution may be appropriately selected in consideration of a personalized learning objective, an objective relevance assigned to a node corresponding to at least one learning unit, and another node being connected to with the above node and having a predetermined correlation. For example, a learning solution may be recommended in such a way that academic achievements for specific learning units with high objective relevances and other learning units with high correlations may be evenly increased.

In addition, as mentioned above, the objective relevance and the correlation may be dynamically determined on the basis of academic achievements of a learner for learning units corresponding to nodes that the learner has traversed on a knowledge map while performing a learning solution, and thus the learning solution may be changed as the academic achievements are changed while the learner performs the learning solution.

Specifically, according to one embodiment of the invention, periodic evaluation of a learning result and feedback based on the evaluation may be simultaneously carried out while a learning solution is in progress. The evaluation of the learning result may include evaluation of the learner. For example, the evaluation of the learner may include evaluation of academic achievements of the learner for learning units included in the learning solution. The evaluation of the academic achievements may be carried out by conducting an academic achievement test every time a predetermined learning progresses or every predetermined period, and feedback may be made thereon as necessary. The feedback may include a process of supplementing or changing the learning solution according to the academic achievements of the learner, and the feedback may be provided together with information that may be helpful for learning strategies, such as information on entrance examinations.

Meanwhile, the learning solution may include a learning methodology, a customized learning course according to the learner's level, supplementary learning for learning units with low academic achievements, a psychological counseling course, and the like. However, the learning solution according to the invention is not limited to those mentioned above, and may be diversely changed as long as the objects of the invention may be achieved.

Further, information on an appropriate learning solution, which may be recommended in consideration of a personalized learning objective and an objective relevance assigned to a node corresponding to at least one learning unit, may be separately stored in a learning solution database in which the personalized learning objective and the learning solution are matched and stored. In this case, the learning solution corresponding to the personalized learning objective of the learner may be automatically recommended. In addition, there may be a plurality of recommended learning solutions, in which case the learner may refer to each learning solution and its description to select one learning solution or a plurality of learning solutions. When this process takes place offline, the learner may be recommended a learning solution appropriate for the personalized learning objective through direct communication with the service provider.

Although some embodiments have been described above, the present invention is not necessarily limited to the aforementioned embodiments. It is noted that any learnable subjects regardless of courses or fields may be learning units according to the invention.

Meanwhile, the above education service provision process according to the embodiments of the invention may be performed in both online environment and offline environment as described above. Even if any one step is performed in the online environment, other steps may be performed in the offline environment, and vice versa.

Meanwhile, the communication unit 240 according to one embodiment of the invention may function to enable the learning solution provision system 200 to communicate with an external device such as the user terminal device 300.

Lastly, the control unit 250 according to one embodiment of the invention may function to control data flow among the learning objective management unit 210, the relevance management unit 220, the recommendation unit 230, and the communication unit 240. That is, the control unit 250 may control inbound data flow or data flow among the respective components of the learning solution provision system 200, such that the learning objective management unit 210, the relevance management unit 220, the recommendation unit 230, and the communication unit 240 may carry out their particular functions, respectively.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method performed in a system for providing a customized education service to a learner, the system comprising a learning objective management unit, a relevance management unit, and a recommendation unit, and the method comprising the steps of:
by the learning objective management unit, determining a personalized learning objective on the basis of at least one learning objective provided from a learner;
by the relevance management unit, determining an objective relevance for at least one learning unit associated with at least one of the learning objective and the personalized learning objective; and
by the recommendation unit, recommending the learner a learning solution associated with at least one learning unit for which the objective relevance is not less than a predetermined level,
wherein the step of determining the personalized learning objective comprises the step of determining the personalized learning objective on the further basis of the objective relevance determined by the relevance management unit.

2. The method of claim 1, wherein the learning solution is recommended with reference to at least one learning unit having a predetermined correlation with the learning unit for which the objective relevance is not less than the predetermined level, and
wherein the predetermined correlation is acquired from a knowledge map including two or more nodes each corresponding to the learning unit for which the objective relevance is not less than the predetermined level and the at least one learning unit having the predetermined correlation therewith, and at least one link which connects the two or more nodes and is assigned the correlation between the two or more nodes.

3. The method of claim 1, wherein the objective relevance is dynamically determined by the relevance management unit on the basis of nodes that at least one learner has traversed while performing the learning solution, or academic achievements of the at least one learner for learning units corresponding to the traversed nodes.

4. The method of claim 2, wherein the correlation between the two or more nodes is dynamically determined by the relevance management unit on the basis of nodes and links that at least one learner has traversed while performing the learning solution, or academic achievements of the at least one learner for learning units corresponding to the traversed nodes.

5. The method of claim 2, wherein the nodes and links included in the knowledge map are defined on the basis of a predefined learning system.

6. A non-transitory computer-readable recording medium having stored thereon a computer program for executing the method of claim 1.

7. A system for providing a customized education service to a learner, the system comprising:
a learning objective management unit configured to determine a personalized learning objective on the basis of at least one learning objective provided from a learner;
a relevance management unit configured to determine an objective relevance for at least one learning unit associated with at least one of the learning objective and the personalized learning objective; and
a recommendation unit configured to recommend the learner a learning solution associated with at least one learning unit for which the objective relevance is not less than a predetermined level,
wherein the learning objective management unit is configured to determine the personalized learning objective on the further basis of the objective relevance determined by the relevance management unit.
